(19) United States
(12) Patent Application Publication
(10) Pub. No.: US 2010/0174664 A1
(43) Pub. Date: Jul. 8, 2010

(54) ETF Trading in Secondary Market Based on Underlying Basket

(75) Inventors: Tony E. Kelly, Walnut Creek, CA (US); Leland C. Clemons, San Francisco, CA (US); Cole B. Feinberg, San Francisco, CA (US)

Correspondence Address: FENWICK & WEST LLP, SILICON VALLEY CENTER, 801 CALIFORNIA STREET, MOUNTAIN VIEW, CA, 94041, US

(73) Assignee: BLACKROCK INSTITUTIONAL TRUST COMPANY, N.A., San Francisco, CA (US)

(21) Appl. No.: 12/651,976

(22) Filed: Jan. 4, 2010

Related U.S. Application Data
(60) Provisional application No. 61/142,609, filed on Jan. 5, 2009.

(51) Int. Cl. G06Q 40/00

(52) U.S. Cl. 705/36 R; 705/37

(57) ABSTRACT

A trading system enables investors to execute trades electronically on exchange at prices that are chosen in consideration of the derivative nature of ETFs as a portfolio of securities or other financial instruments. In addition to measuring liquidity in the ETF itself on exchange, the trading system analyzes the liquidity of the ETF's underlying portfolio to understand the liquidity that is available to investors in the ETF through the creation/redemption process. By monitoring the bid/ask spread of both the ETF and the underlying portfolio in real time, the trading system enables investors to leverage the full potential liquidity of ETFs. The trading system can be used to manage the data and pricing infrastructure for identifying these liquidity replenishment points and to make these prices actionable for investors.

### CROSS REFERENCE TO RELATED APPLICATIONS

This application claims the benefit of U.S. Provisional Application No. 61/142,609, filed Jan. 5, 2009, which is incorporated by reference in its entirety.

### BACKGROUND

This invention relates generally to financial services and products, and more particularly to pricing systems for exchange-traded funds.

Exchange-traded funds, or ETFs, are securities that represent a legal right of ownership over an underlying portfolio of securities or other assets held by the issuing fund. The assets held in an ETF may include individual stocks, bonds, cash, commodities, derivatives, or any tradable asset, including contracts based on the value of any of the foregoing. Shares of an ETF are designed to be listed on a securities exchange and traded over the exchange just like other securities. ETFs thus allow an investor to own a set or “basket” of assets by simply purchasing shares in the individual ETF. Many existing ETFs hold a mix of assets that aim to replicate or otherwise match the characteristics of a particular published index although some ETFs may also follow active management strategies. These ETFs allow investors to have exposure to the index or other applicable active investment strategy by purchasing shares of the single ETF. Because of their low cost and tax advantages, ETFs have grown in popularity in recent years.

An ETF is a type of regulated investment fund with characteristics of both an index mutual fund and a closed-end fund. An ETF resembles an index mutual fund in that an ETF generally holds a basket of securities designed to replicate the returns of a securities index, but generally has lower fees than comparable actively-managed mutual funds, and is required to permit daily redemptions at the current value of its holdings (also known as “Net Asset Value”). An ETF resembles a closed-end fund in that its shares trade on an exchange throughout the trading day and most investors buy and sell shares on the exchange (rather than direct purchases and redemptions from the fund itself, as is the case with mutual funds). Most ETFs are index-based strategies; however, more recently, active (i.e., actively-managed) ETFs have also entered the marketplace. Unlike mutual funds, most transactions in ETF shares are conducted in the secondary market (i.e., on an exchange) and do not involve the movement of assets in or out of the fund. In the case of transactions in creation units that do involve the movement of assets into or out of the fund, the transactions are routinely effected in kind, which mitigates trading costs and tax consequences on the remaining non-transacting shareholders.

ETFs have two types of investors: large, institutional, sophisticated trading desks, known as “Authorized Participants,” which transact directly with the ETF, and other institutional and non-institutional investors. All investors, including Authorized Participants, can buy and sell shares of an ETF on an exchange throughout the trading day, like a stock, including the ability to sell shares “short.” In addition, Authorized Participants can purchase or redeem shares from the ETF at the current value of the ETF's holdings at the end of each trading day, but must do so in large blocks of shares (sometimes referred to as “creation units”). Purchases and redemptions of creation units are typically done by means of the Authorized Participant and the ETF exchanging ETF shares for a block of the ETF's underlying holdings having a value equal to the ETF shares. This has the effect of low fees and low trading costs associated with ETFs.

Because ETFs deal directly only with a few dozen Authorized Participants, their administrative costs are lower than is typical for mutual funds. The administrative savings are generally passed on to ETF shareholders through low fees. In addition, because ETFs transact with Authorized Participants in kind by exchanging ETF shares for fund holdings, or vice versa, they do not need to buy or sell securities in response to daily cash flows like a mutual fund. Instead, the costs of buying and selling securities as the result of movements in and out of the fund are externalized to the Authorized Participants.

This structure provides Authorized Participants and other large financial institutions the ability to engage in arbitrage and market making activities in ETF shares. Authorized Participants may buy or sell shares on the exchange, or also purchase or redeem shares directly from the ETF sponsor at the current value of the ETF's holdings, as represented by the ETF's NAV. In the event that the trading price of an ETF's shares on an exchange drifts away from the current value of the ETF's holdings, an Authorized Participant can make a trading profit by exploiting such price differences. By engaging in such arbitrage and market making transactions throughout the trading day whenever an ETF's share price varies from the value of its underlying holdings, the Authorized Participants quickly provide liquidity whenever there is an imbalance of buy or sell orders for ETF shares that may otherwise cause the shares to trade at a premium or discount. By supplying such liquidity, the Authorized Participants create tighter spreads in the marketplace and generally ensure that the exchange price generally tracks the value of the ETF's holdings closely, which benefits all investors.

The structure of an ETF also incentivizes market makers to compete in their quoting of ETFs in the secondary market relative to the spreads in the underlying portfolio securities. This competition further tightens spreads and enhances liquidity for investors in the secondary market.

The ETF industry and its products are founded on Authorized Participants and other large institutional market participants' ability to price and trade the underlying portfolio securities that make up an ETF. ETF sponsors (i.e., fund managers) publish each business day the list of securities that can be exchanged for equivalent value of ETF shares through the creation/redemption process. Currently, investors may contact a broker dealer with a request for quote on an amount of shares in an ETF. The broker will then price out the cost to trade the underlying securities and in turn offer to sell the ETF to the client at the equivalent price (usually plus some commission). Additionally, retail investors can enter a trade through their intermediary trading account, but with no idea of the pricing parity at which a broker would buy or sell shares in the ETF based on the equivalent cost to trade the underlying basket of securities, due to the significant technology commitment required. The result is that many clients are unable to benefit from the liquidity associated with the underlying securities and the ETF due to limitations in their execution capability. This is particularly true for large trade sizes given the market's migration towards displayed quotes representing smaller sizes and non-displayed or “hidden” quotes representing the larger volumes where broker dealers and market makers are willing to transact at sometimes wider spreads.

Because an ETF holds a basket of securities, and new shares of the ETF are generally created by obtaining those securities through the in-kind creation process, ETFs have an inherent “hidden liquidity” that leverages the liquidity of their underlying portfolio securities. Again, the liquidity can be considered “hidden” to certain investors because the price brokers dealers and market makers may be willing to buy and sell an ETF's underlying securities in response to certain execution orders is not readily available to those investors; thus, many investors are not aware of the potentially better prices at which they could execute trades. With existing systems, however, the amount and cost of data necessary to understand and identify an ETF's hidden liquidity is prohibitive for most investors and their brokers. Developments in the way U.S. equities are traded have further exacerbated the challenges facing investors in their trading activities. As trading has become more electronic, the ability for market makers to step in to provide deeper markets at their displayed bid/offer quotes has been diminished.

FIG. 1 illustrates the bid and offer prices for a typical ETF and the basket of underlying portfolio securities for the ETF. The spread between the bid and offer prices for the ETF (in this example, $0.06) can be much tighter than the spread for the underlying portfolio securities (in this example, $0.15), which is typical for the aforementioned reasons. However, the underlying securities offer a separate source of liquidity, which can be more liquid than the shares of the ETF itself As illustrated, only 500 shares of the ETF are available at the lowest offer price, $50.06. Another 1000 shares are available at $50.08, 1000 shares at $50.10, 2000 shares at $50.12, 5500 shares at $50.14, and so on. If an investor were to buy 10,000 shares of the ETF, the average price would be over $50.12, which would be higher than the $50.10 value of the underlying portfolio securities. Accordingly, the benefit of “price efficiency” due to the tighter bid/ask spread of the ETF in this example is diminished due to the lack of displayed quotes on a national stock exchange, which may cause a run up in the execution price when large blocks of shares are purchased).

Some existing trading and pricing systems address the liquidity constraints when trading large blocks of individual securities by breaking up the trade into smaller trade amounts so as not to “tip the investor's hat” by showing the entire order in the hopes or receiving more efficient execution since quotes at a larger trade size may be unavailable. The intent of these systems is to ease the trade into the market when displayed liquidity seems to be available in an effort to limit the market impact of the trade. Two of the most prominent strategies used by current algorithms to achieve this: (1) volume-weighted average price (VWAP), which tries to match the average price over the day based off the volume in the security; and (2) time-weighted average price (TWAP), which seeks to match the average price for a specified time during the trading day(s). Although these strategies may be effective for individual securities because they can minimize market impact by taking a longer trade horizon, they do not always take advantage of an ETF's structure and the underlying liquidity source ETFs provide. Also, inherent in these types of trades is a greater risk that the price of a stock will move for reasons independent of the investor's specific trade, which may occur while a trading system waits for displayed liquidity to appear in the market. For this reason, these existing systems are less effective at balancing the competing risks of market impact and volatility/price movement for ETFs.

Despite the growth in ETF trading volumes, no real advancements have been made across electronic trading strategies offered to sales traders or buy-side investors. What is needed, therefore, are pricing strategies and trading systems for conducting market trades that address these issues and take advantage of the transparency and liquidity associated with the ETF structure. In particular, for an investor who wants to buy large number of ETF shares and does not have access to an Authorized Participant (for creation of new ETF shares), it would logically be desirable to avoid paying a higher market price per share than the price a broker can provide for accessing the basket of underlying portfolio securities specific to that ETF.

### SUMMARY

Embodiments of the invention provide a trading system that enables investors to execute trades electronically on an exchange at prices that are chosen in consideration of the derivative nature of ETFs as a portfolio of securities. In addition to measuring volume in the ETF itself on exchange, the trading system analyzes the liquidity of the ETF's underlying portfolio to understand the “hidden” liquidity that is available to investors in the ETF through the creation/redemption process. By monitoring the bid/ask spread of both the ETF and the underlying portfolio in real time, the trading system enables investors to leverage the full potential liquidity of ETFs on both the-exchange as well as the underlying “hidden” liquidity. The trading system can be used to manage the data and pricing infrastructure for identifying these liquidity sources and execution prices and then to make these prices actionable for investors.

### BRIEF DESCRIPTION OF THE DRAWINGS

FIG. 1 is an example of the bid/ask spread of an example ETF and its underlying portfolio of securities.

FIG. 2 is a diagram of a system allowing an investor to obtain ETF shares from an exchange using a trading system, in accordance with an embodiment of the invention.

FIG. 3 illustrates a creation process for an ETF in a primary market, in accordance with one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of Concepts

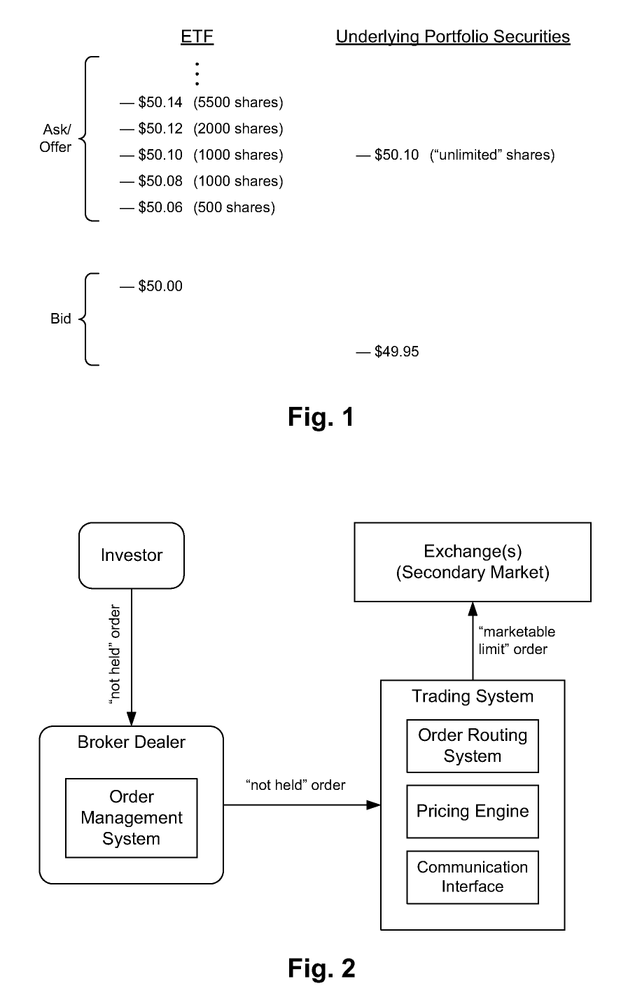

FIG. 1 illustrates how the hidden liquidity of an example ETF can be exploited to obtain a better purchase price for a large block of shares. Recalling the discussion above, an investor purchasing 10,000 shares of the ETF would have to pay over $50.12 per share based on the existing book of offers. This is undesirable and unnecessary, since the underlying portfolio securities can be obtained for an equivalent of $50.10 per share. Due to the transparent and unique structure of ETFs, the investor generally should not accept a purchase price above the offer price of the underlying securities (which is $50.10 in this example). If the investor offers to pay a sufficiently high price for the ETF, yet one that is still in line with the cost an investor would have to pay for the offered underlying securities, there is an opportunity for Authorized Participants and other similar market participants to create new shares of the ETF in the primary market and offer those new shares to the investor in the secondary market at or about the average price of the underlying portfolio securities. In this way, the investor obtains a better average share price for the ETF by offering to pay a price that is sufficient to induce others to create new ETF shares using the underlying portfolio securities, thereby accessing the hidden liquidity.

Because of the ETF structure and the arbitrage opportunity discussed above, market participants will frequently provide liquidity at prices equivalent to the cost to trade the underlying portfolio securities. In the example of FIG. 1, market makers would be willing to provide sell-side liquidity at prices just above $50.10, the price of the underlying basket. This creates an arbitrage band, where market makers will buy shares of the securities in the underlying basket and create and sell shares of the ETF. Conversely, market makers would be willing to provide buy-side liquidity at prices just below $49.95, the bid price of the underlying basket. This creates another arbitrage band, where market makers will buy and redeem shares of the ETF and then sell shares of the securities in the underlying basket. The challenge facing investors is to determine where this price point exists throughout the trading day given the amount of data necessary to calculate these price points intraday. Embodiments of the invention determine the spread between these arbitrage bands intraday, in real time throughout the day, to determine the appropriate marketable limit price at which a trade should be sent to the exchanges.

Embodiments of the invention provide just that, a trading system that determines a price for the investor to offer and that acts on that determination by making the offer in the secondary market. More specifically, the trading system determines the price at which to place a bid to entice sufficient supply of ETF shares. Beneficially, this price can be determined before the trade, not after it, to minimize the investor's market impact.

### Operation of the Trading System

In one embodiment, illustrated in FIG. 2, an investor enters a market order “not held” within their order management system. This market order is received by a communication interface of the trading system and routed to a pricing engine in the trading system. In one embodiment, the pricing engine is implemented as a computer program executed on a computer system. The pricing engine calculates the cost to trade the ETF as if it were a single stock without a continuous share offering. Referred to as “pre-trade analysis,” the process is widely used across trading desks for calculating trade costs in single stock transactions. Although service providers differ in their calculations of market impact, the most heavily weighted variables are usually average daily volume and a stock's volatility. The novel pricing engine described herein also calculates the cost to trade the ETF's underlying portfolio securities, which can be exchanged to an ETF sponsor for ETF shares in connection with a creation or redemption transaction based on the current “portfolio composition file” (PCF) that is published each business day for the ETF. In accordance with an embodiment of the invention, the pricing engine selects the lesser of these two numbers (lower market impact), which the trading system uses as the suggested trade cost for the investor's order in the public exchange marketplace.

Once the expected trade cost has been calculated, the trading engine sends a message to its order routing system to place a “marketable limit order” for the trade at a price equivalent to the current bid/offer plus the expected market impact of the trade. In one embodiment, the order routing system is implemented as a computer program executed on a computer system. To access the full market liquidity and to achieve the best possible price, the full order is preferably represented in the marketplace. To achieve an accurate suggested trade cost, the pricing engine may update in real time based on second-by-second fluctuations in market price of the ETF as well as its underlying portfolio of securities.

Because an ETF is both a single security and represents a portfolio of securities or other financial instruments, the trading system may consider the trading volume of the ETF and the trading volume of the underlying portfolio, as well as the frequency with which the quotes update across the securities and the price discrepancy between an ETF and its underlying portfolio.

The trading system, in accordance with an embodiment of the invention, minimizes both market impact and time horizon (volatility) risk by leveraging the unique structure of ETFs and the use of marketable limit orders. Within the trading system, communication and publishing of trades can take place within seconds of the investor's order being submitted. In this way the investor can receive a faster and better execution of the trade (both in terms of speed as well as price, as a result of minimizing market impact) by leveraging the underlying portfolio liquidity. This approach is opposite to previous and common approaches to the liquidity problem, which divide a large order into small pieces to conceal execution intentions.

An embodiment of the trading system may also provide post-trade analysis to the investor showing the quality of execution relative to ETF being traded as well as the underlying portfolio securities that constitute the ETF.

Pricing Algorithm for the Secondary Market

Below is a description of the pricing engine and transaction cost methodology used to determine a price and execution strategy for a market trade for a requested number of shares of an ETF, in accordance with an embodiment of the invention. It will be appreciated that modifications to many of the parameters mentioned in this algorithm, as well as modifications to the overall algorithm such as additional or fewer steps, are possible within the scope and context of embodiments of the invention.

First, the engine calculates a trade cost estimate considering the specific ETF trade size relative to the average daily volume of the ETF in the secondary market, as well as the ETF's volatility relative to broad indices like the S&P 500, and the depth of liquidity indicated by average quote size on the bid and offer, depending on whether the trade is a buy or sell. Second, the engine calculates a trade cost estimate considering the ETF trade as a portfolio trade by breaking the trade value up into smaller trades with weights representative of those published in the daily ETF portfolio composition file that is published via the NSCC. In consideration of a trade cost estimate, the pricing engine may also consider broker dealer costs to provide liquidity, such as stamp taxes, clearing costs, creation/redemption fees, and other frictional costs pertinent to the particular ETF as part of the trade cost estimate.

In this way, an otherwise large trade in the ETF itself may be a series of relatively small trades across many individual stocks comprising that ETF's underlying basket. The engine will then compare the two trade cost estimates and recommend a trading strategy using marketable limit orders in the ETF, but based off of an analysis of both the ETF and underlying liquidity sources. The marketable limit order will be placed either above the offer (to buy) or below the bid (to sell), and the price selected will be at the lower of the two trade cost estimates described above.

In practice, an order management system and trading software may manage communication of the trade information from the customer and then to the market centers (exchanges and other market centers where ETFs are traded).

### ETF Overview

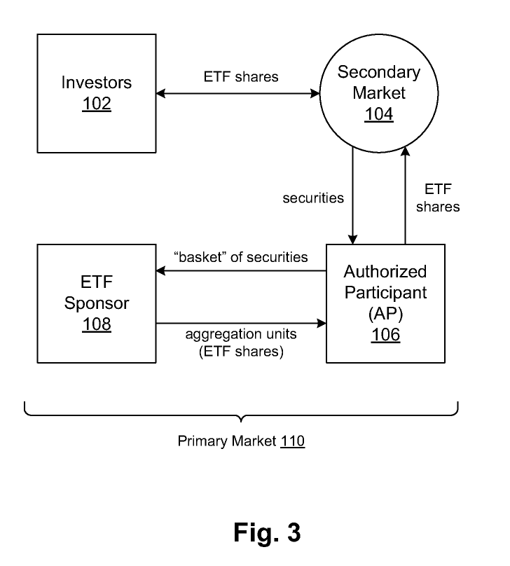

FIG. 3 illustrates a simplified creation process for an ETF (or “fund”), in the primary market 110 in accordance with one embodiment. In this process, the shares of an ETF are generally made available to investors 102 through a two-tiered market structure, which includes a primary market 110 and a secondary market 104. In the primary market 110, issuance of new shares of the ETF can be created only in multiples of a minimum block of shares (“creation units”). Because of the large size of the minimum creation units required for purchases of new ETF shares, these shares are generally only available in the primary market 110 to certain institutional investors known as authorized participants 106. Authorized participants 106 are typically large institutional broker dealers or market makers that transact directly with an ETF for purchases of creation units of the ETF shares at the end of day net asset value (“NAV”) for the ETF.

As shown, the consideration for purchase of a creation unit of an ETF generally consists of a deposit of a basket of securities via an in-kind exchange of those securities and a deposit of cash to make up any difference between the value of the deposit securities delivered into the ETF and the value of the shares of the ETF (or NAV) issued 108 to the authorized participant 106. In certain circumstances, cash may also be delivered in lieu of all or a portion of the specified basket of securities if the securities are not available in sufficient quantity or otherwise cannot be delivered or in certain other situations. The deposit securities are obtained and delivered by the authorized participant 106 to the ETF, which are then added to the ETF's holdings. The particular mix of securities required to be deposited by the authorized participant 106 in exchange for a creation unit of the ETF are specified by a “basket,” which is published by the ETF sponsor 108 each business day in a portfolio composition file (PCF).

The opposite process occurs for a redemption of the ETF. In one embodiment, an authorized participant 106 can redeem shares of an ETF by delivering a block of the ETF shares (e.g., the same size block as in a creation unit) to the ETF. In exchange, the ETF delivers via an in-kind transfer the deposit securities specified in the published basket (e.g., in the PCF) associated with the ETF. In both the creation and redemption processes, a cash component is delivered in either direction to offset any differences between the actual value of the deposit securities and that of the ETF shares exchanged, as represented by the NAV of the ETF. As stated earlier, in certain circumstances, cash may also be delivered in lieu of all or a portion of the specified basket of securities if the securities are not available in sufficient quantity or otherwise cannot be delivered or in certain other situations.

In contrast to the primary market 110, in which authorized participants 106 may transact for the creation or redemption of creation size units of an ETF, most investors 102 can access ETF shares in the secondary market 104. Once the block of ETF shares in the creation size units is received by the authorized participant 106, the shares may be broken down into less than creation unit sizes (including individual shares) and sold by the authorized participant 106 directly to customers or over a secondary market 104, where individual investors 102 may buy and sell shares of the ETF through their brokerage accounts. An intermediary, such as a broker/dealer or financial advisor, may advise investors 102 directly and recommend the buy or sell of ETF shares.

The process flow and systems for trading ETFs are described in more detail in U.S. application Ser. No. 12/168,036, filed Jul. 3, 2008, which is incorporated by reference in its entirety.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, the techniques described herein may be applied to other financial instruments, possibly those not yet created, where shares of the instrument are traded and are based on an underlying set of tradable securities or other items.

Some portions of this description detail the embodiments of the invention in terms of algorithms and symbolic representations of operations on information. These algorithmic descriptions and representations are commonly used by those skilled in the art to convey the substance of their work effectively to others skilled in the art. These operations, while described functionally, computationally, or logically, may be understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Such a computer program may be stored in a tangible computer readable storage medium, e.g., or any type of non-transitory medium suitable for storing electronic instructions. Embodiments of the invention may also relate to an apparatus for performing the operations described herein. This apparatus may be specially constructed for the required purposes, and/or it may comprise a general-purpose computing device selectively activated or reconfigured by a computer program stored in the computer.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon.

What is claimed is:

1. A method for trading shares of an ETF in a secondary market, the method comprising:
receiving in a trading system an order for a number of shares of an ETF, the ETF based on an underlying basket of financial instruments;
determining a target price for the ordered number of shares of the ETF, the target price determined by a computer system as a function of a price per share of the underlying basket of financial instruments that make up the ETF; and
electronically placing a limit order into a market for the ordered number of shares of the ETF at the determined target price.

2. The method of claim 1, wherein determining the target price comprises selecting the lower of: (1) a price sufficient to fulfill the ordered number of shares based on existing offers for the ETF on the secondary market, and (2) a price per share of the underlying basket of financial instruments that make up the ETF.

3. The method of claim 1, further comprising:
accessing a listing of offers for the ETF on the secondary market, each offer specifying an offer price for the ETF and a number of shares available at that offer price; and
if the offer price of one or more of the offers for the ETF on the secondary market is below a value of the underlying basket on a per share basis, electronically purchasing shares of the ETF based on one or more of the offers on the secondary market.

4. The method of claim 3, further comprising:
if the listing includes offers for the ETF for a sufficient number of shares to satisfy the ordered number of shares below the determined target price, electronically purchasing the ordered number of shares of the ETF based on one or more of the offers on the secondary market.

5. The method of claim 1, further comprising:
accessing a listing of offers for the ETF on the secondary market, each offer specifying an offer price for the ETF and a number of shares available at that offer price;
electronically purchasing less than the ordered number of shares of the ETF based on one or more of the offers on the secondary market;
waiting until a sufficient number of shares of the ETF are available at or below a value of the underlying basket on a per share basis, after the step of electronically placing the limit order; and
electronically purchasing a sufficient number of shares of the ETF to satisfy the ordered number of shares of the ETF.

6. The method of claim 1, further comprising:
if the ordered number of shares of the ETF are available at or below a value of the underlying basket on a per share basis, electronically purchasing the ordered number of shares from an existing set of offers for the ETF on the secondary market; and
if less than the ordered number of shares of the ETF are available at or below the determined target price, electronically purchasing shares from an existing set of offers for the ETF on the secondary market that are within the determined target price, and waiting for additional offers for the ETF on the secondary market at or below the value of the underlying basket on a per share basis.

7. The method of claim 1, wherein determining the target price comprises, if a sufficient number of shares of the ETF exist below the price per share of the ETF of the underlying basket of financial instruments that make up the ETF, determining the target price corresponding to offers having the lowest price sufficient to satisfy the ordered number of shared of the ETF.

8. The method of claim 1, wherein determining the target price comprises capping the target price at an amount just above the price per share of the ETF of the underlying basket of financial instruments that make up the ETF.

9. The method of claim 1, wherein the determined target price is further based on estimated broker dealer costs associated to provide liquidity of the ETF.

10. A method for trading shares of an ETF in a secondary market, the method comprising:
receiving in a trading system an electronic order for a number of shares of an ETF, the ETF based on an underlying basket of tradable financial instruments;
determining a target price for the number of shares of the ETF, the target price determined by a computer system as a function of:
a set of offers for the ETF on a secondary market, each offer specifying a price for the ETF and a number of shares available at that price, and
a price per share of the ETF of the underlying basket of financial instruments that make up the ETF; and
electronically placing a limit order into a market for the ordered number of shares of the ETF at the determined target price.

11. The method of claim 10, wherein determining the target price comprises selecting the lower of: (1) a price sufficient to fulfill the ordered number of shares based on existing offers for the ETF on the secondary market, and (2) a price per share of the underlying basket of financial instruments that make up the ETF.

12. The method of claim 10, further comprising:
if the ordered number of shares of the ETF are available at or below the determined target price, electronically purchasing the ordered number of shares from an existing set of offers for the ETF on the secondary market; and
if less than the ordered number of shares of the ETF are available at or below the determined target price, electronically purchasing shares from an existing set of offers for the ETF on the secondary market that are within the determined target price, and waiting for additional offers for the ETF on the secondary market at or below the determined target price.

13. A computer program product for trading shares of an ETF in a secondary market, the computer program product comprising a computer-readable storage medium containing computer program code for:
receiving an electronic order for a number of shares of an ETF, the ETF based on an underlying basket of tradable financial instruments;
determining a target price for the ordered number of shares of the ETF, the target price determined as a function of a price per share of the underlying basket of financial instruments that make up the ETF; and
electronically placing a limit order into a market for the ordered number of shares of the ETF at the determined target price.

14. The computer program product of claim 13, wherein determining the target price comprises selecting the lower of: (1) a price sufficient to fulfill the ordered number of shares based on existing offers for the ETF on the secondary market, and (2) a price per share of the underlying basket of financial instruments that make up the ETF.

15. The computer program product of claim 13, the computer-readable storage medium further containing computer program code for:
if the ordered number of shares of the ETF are available at or below the determined target price, electronically purchasing the ordered number of shares from an existing set of offers for the ETF on the secondary market; and
if less than the ordered number of shares of the ETF are available at or below the determined target price, electronically purchasing shares from an existing set of offers for the ETF on the secondary market that are within the determined target price, and waiting for additional offers for the ETF on the secondary market at or below the determined target price.

16. The computer program product of claim 13, wherein the determined target price is further based on estimated broker dealer costs associated to provide liquidity of the ETF.

17. A trading system for trading shares of an ETF in a secondary market, the system comprising:
a communication interface for receiving an electronic order for a number of shares of an ETF, the ETF based on an underlying basket of tradable financial instruments;
a pricing engine configured to determine a target price for the ordered number of shares of the ETF, the target price determined as a function of a price per share of the underlying basket of financial instruments that make up the ETF; and
an order routing system coupled to the pricing engine to receive the determined target price therefrom, the order routing engine further configured to communicate electronically with a market to place a limit order for the ordered number of shares of the ETF at the target price determined by the pricing engine.

18. The trading system of claim 17, wherein the pricing system is configured to determine the target price by selecting the lower of: (1) a price sufficient to fulfill the ordered number of shares based on existing offers for the ETF on the secondary market, and (2) a price per share of the underlying basket of financial instruments that make up the ETF.

19. The trading system of claim 17, wherein the order routing system is configured to:
if the ordered number of shares of the ETF are available at or below the determined target price, purchase the ordered number of shares from an existing set of offers for the ETF on the secondary market; and
if less than the ordered number of shares of the ETF are available at or below the determined target price, purchase shares from an existing set of offers for the ETF on the secondary market that are within the determined target price, and waiting for additional offers for the ETF on the secondary market at or below the determined target price.

20. The trading system of claim 17, wherein the pricing engine is further configured to determine the target price based on estimated broker dealer costs associated to provide liquidity of the ETF.
